(19) United States
(12) Patent Application Publication
(10) Pub. No.: US 2011/0260478 A1
(43) Pub. Date: Oct. 27, 2011

(54) Cat Box Litter Box Scooper

(76) Inventor: Camilla Emmans, Anoka, MN (US)

(21) Appl. No.: 12/764,400

(22) Filed: Apr. 21, 2010

(51) Int. Cl. A01K 29/00; B07B 1/02

(52) U.S. Cl. 294/1.3; 209/418; 119/166

(57) ABSTRACT

A scoop strainer is disclosed which may be easily sterilized and which is used for a small animal litter box. The scoop strainer has a base and a curved handle. The base of the scoop strainer has a straight front edge and a planar front face which extends downward and inward from the front edge in a rectangular shape. An arcuate basket edge or rim extends from one end of the front edge to the opposite side of the front edge. A back face and opposed side faces extend downward from the back and side portion of the basket edge or rim.

### FIELD OF THE INVENTION

This invention relates generally to a tool used to sift and separate different sized particles and more particularly to a scoop used to separate used animal litter from unused litter and has uniformly sized and shaped holes.

### BACKGROUND OF THE INVENTION

Cats and other small animals are typically not let outside of an owner's home to relieve themselves. Such animals are trained use litter boxes kept inside a person's home. Due to the excrement in a litter box, such items can cause many problems if not effectively cleaned.

Litter, cat litter or kitty litter is a material (or combination of materials) which is placed in a litter box to absorb moisture from small animal feces and urine. Litter is typically used to ease in cleaning up after small animals and to assist in eliminating odors produced by animal excrement.

There are several types of litter on the market including: non-clumping litter, clumping litter, biodegradable litter, and silica gel litter. Non-clumping litter is a clay-based litter which has grains, or particles, larger than sand. The size of the particles minimizes the amount of litter which may be tracked outside of a little box. Non-clumping litter is often the most inexpensive litter sold. One of the disadvantages in using non-clumping litter is that it is often difficult to clean and requires frequent complete removal of all of the litter. Clumping litter is a variety of litter which bonds together when the litter has been used. Most clumping litter is made from varieties of clays which clump together when wet and forms solid masses which separates from the remaining litter in the litter box. A disadvantage to clumping litter is that to effectively dispose of clumped litter, the majority of the contents of the litter box must be thrown away and, therefore, often unused litter is disposed with used litter. Clumping litter also needs to be completely replaced every week or so, depending on the type, size and number of cats using the litter box.

Biodegradable litter is generally made from plant resources. Biodegradable litter may be clumping (such as a variety of saw dust) or non-clumping. Biodegradable litter may be used for longer periods of time than traditional litter before cleaning of a litter box is needed because of its superior deodorizing properties. Because, biodegradable litter is more expensive than traditional litter and it is not as frequently used as clumping litter.

Silica gel litter is known to have the highest absorbency of any litter available in the market. Silica gel litter, while it has the advantage of high absorbency, tends to be unpredictable as to when it is completely saturated; therefore means a small animal owner may not know when the litter will no longer be absorbent. While there are disadvantages to clumping letter, the advantages, such as visibility when it has been used, low cost and minimal odor, leads to most small animal owners using clumping litter in their litter boxes.

The typical small animal owner will remove excrement from a litter box daily to a few times a week, and completely replace all of the litter at least once a week or once every other week. The need to clean a litter box this many times is because traditional clumping litter will not effectively remove all odors produced from excrement; therefore, after several uses, the odors generally become undesirable.

Each time a litter box is cleaned, between complete changes of the litter, unused litter is removed from the litter box in addition to used litter. This is seen to be wasteful by small animal owners because otherwise good litter is unnecessarily thrown away, but it is seen as generally unavoidable.

The traditional method of removing used litter from a litter box involves using a specially designed sifter or scoop which has slots or holes in its base. These slots and holes are generally designed to retain used, clumped litter and allow some of the unclumped litter to return to the litter box. However, these holes and slots almost always also let smaller clumps of used litter to fall back into the litter box and sometimes not allow all of the unused litter to fall back into the litter box. Therefore, even if the small animal owner desires to remove all used litter from a litter box, it rarely occurs because some used litter will almost always fall through the slots or holes of a scoop. Allowing used litter to remain in a litter box leads to an increase in the odors emitted from the litter box, an increase in the likelihood of used litter being tracked through a home, and an increase in the likelihood of diseases or illnesses to spread.

Animals may also transmit diseases and illnesses through excrement. Such diseases and illnesses are harmful not only to humans, but also to other animals which may come into contact with used litter. Therefore, for example, if one cat or other small animal is sick, the excrement from that animal could transfer the illness or disease to other animals using that litter box, or even to the animal's owner. Diseases or illness causing organisms could be retained on the surface of a litter scoop if the litter scoop is not properly sterilized after each use.

The need to sterilize a litter scoop is especially important in a veterinary setting, animal foster homes, and animal shelters. The animals which normally pass through these facilities are more likely to be carriers of illnesses and diseases. These facilities also are more likely to have multiple animals using a single litter box. The animals in these facilities are more likely to come into contact with animal excrement of a sick animal; therefore, the likelihood of a previously healthy animal becoming sick is greater. It is extremely important in such facilities for all of the used litter to be removed from a litter box and for the litter scoop to be able to be sterilized.

There is a need for a litter scoop which traps virtually all used litter, while simultaneously allowing non-used litter to return to a litter box. There is also a need for a litter scoop which may be easily sterilized after use in either a home or veterinary setting.

### SUMMARY

The invention provides a scoop strainer for cleaning a cat litter box that comprise a scoop member having a straight front upper edge joined to arcuate upper side and rear edges, the scoop further including a downward and inward sloping planar, rectangular, front face that extends from the front upper edge to a bottom edge. Rounded sidewalls and a rear wall slope inwardly and downwardly from the arcuate upper side and rear edges to a bottom surface where the sidewalls are integrally joined to side edges of the planar front face and to the bottom surface. A handle is joined at one end to the upper rear edge of the scoop member. Further, the planar front face, the rounded side and rear walls and the bottom surface are perforated with apertures of a predetermined size and regular spacing therebetween.

### DESCRIPTION OF THE FIGURES

The foregoing features, objects and advantages of the invention will become apparent to those skilled in the art from the following detailed description of the preferred embodiment, especially when considered in conjunction with the accompanying drawings.

FIG. 1 shows a top view of the scoop.

FIG. 2 shows a side view of the scoop.

FIG. 3 shows a perspective view of the scoop.

### DETAILED DESCRIPTION

The invention is directed to a scoop strainer generally at 2 designed to retain all used litter and small animal waste which enters the scoop and releases substantially all unused litter to the litter back box. The base 10 of the scoop 2 includes holes 12 or openings disposed throughout the base 10 to allow unused particles of litter to return into the litter box. Each of the holes 12 or openings in the base 10 of the scoop 2 are uniform in all dimensions such that an unused particle of litter cannot slip through a hole 12 in one direction but not another. The holes 12 are distributed throughout the bottom surface of the base 10 and throughout all sides of the base 10. It is preferred for the holes 12 to be evenly distributed throughout the base 10.

The holes 12 in the base 10 are sized such that used clumps of litter will not return to the litter box, but are also sized to allow unused litter particles to return to a litter box. It is important for the holes 12 to be uniform in all directions so as to not allow used clumps of litter to return to the box; for it may be possible for clumps to fall through the holes in one direction but not another if the holes are not uniform in shape. Therefore, if the holes are uniform in each direction the likelihood of such an occurrence happening is virtually eliminated. Contemplated uniform shapes may be square or circular. In a preferred embodiment, the holes should be between two and a half (2½) to three and a half (3½) millimeters either in diameter, if the hole is circular, or on a side, if the hole is square. In one preferred embodiment the diameter or side should be three millimeters. These dimensions are some preferable dimensions because they do not allow used litter to pass through, and allow unused litter particles to return to the litter box.

Uniform holes 12 may be formed in the base 10 by any conventional means known in the art, such as by pressing or molding the base to have the desired sized and shaped holes. The base 10 may also be created from a sturdy plastic or mesh material which will provide uniform holes. If a mesh material is used, it should be of a type which will hold its shape and not be easily deformed. Woven or welded wire mesh may be used to form the base. A welded wire mesh will typically hold its form better than a woven wire mesh, for welded wire meshes are generally formed from wire which is larger in diameter than woven mesh and therefore more difficult to deform. Another type of mesh material which holds its form is a perforated mesh, which is formed from punching desired shapes out of a sheet of metal.

Most metals and alloys are contemplated for use in forming the base 10 of the scoop 2. Examples of preferred metals include steel, stainless steel, hi-tensile steel, aluminum and brass. Metals and alloys are the preferred material because of their relative ease to sterilize. The scoop 2 may also be made from a plastic material which can withstand high temperatures or chemicals which are used for sterilization purposes. Any plastic which may be molded into the desired form, while also being able to withstand high temperatures or chemical sterilants, is also contemplated for use in making the desired scoop.

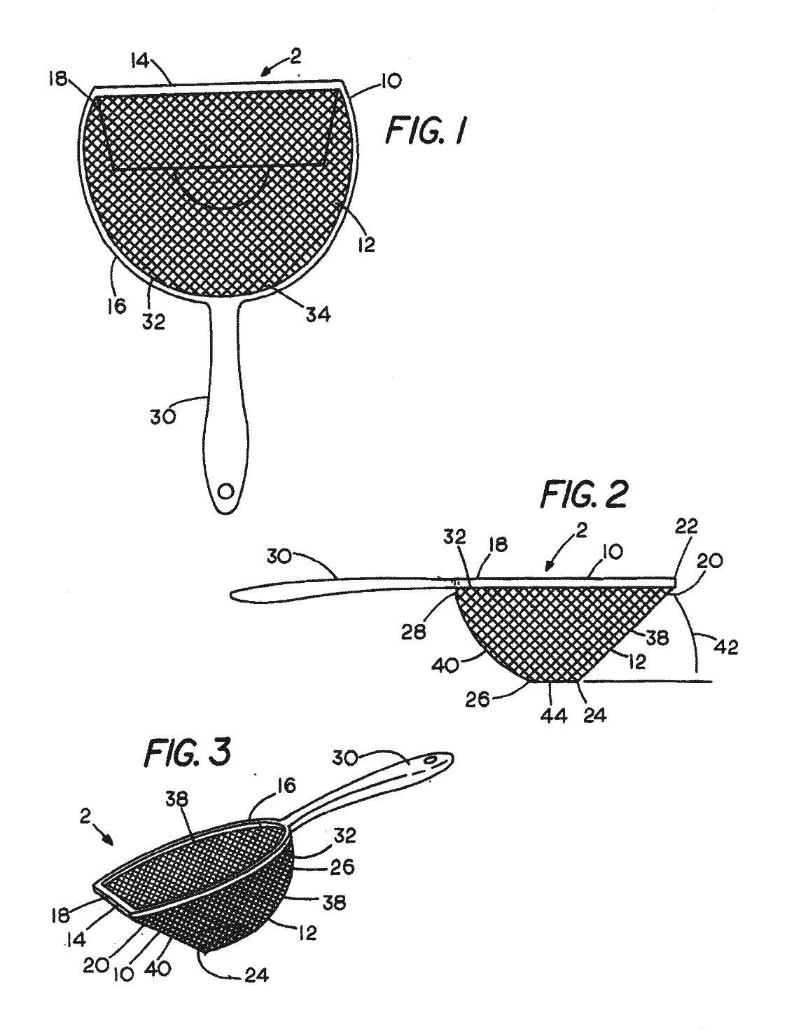

The base 10 of the scoop 2 should be formed with a straight front or leading upper edge 14 and an arcuate basket edge or rim 16 extending from one side of the front edge 14 to the other. In a preferred embodiment, the arcuate upper basket edge 16 curves in a generally circular manner from one end of the front edge 14 to the opposite end of the front edge 14. The shape formed by the front edge 14 and the basket edge 16 forms a top surface 18, as shown in FIG. 1. It is important for the front edge 14 to be linear to ease in collecting used litter from the litter box. The back position 32 of the upper basket edge or rim 16 is the portion thereof that is generally opposite to the front edge 14. The side portions 38 of the basket edge 16 each extend from one end of the front edge 14 to an end of the back edge 32.

Extending down at an angle to the front edge 14 of the base 10 is a front face 20, as shown in FIG. 2. The inclined front face 20 eases in scooping used litter from the litter box. The angle of the front face 20 with respect to the front edge 14 may be any angle which will prevent used litter from falling out of the scope. Without limitation, the angle 42 of the front face 20 with respect to the front edge 14 can be between 30 degrees and 80 degrees. The front face 20 is generally rectangular in shape having its bottom edge 24 equal to the length of the front edge 14 and the two inclined side edges 32 of the front face 40 are equal in length. The desired height of the front edge relative to the bottom of the base 10 should not be greater than the typical height of most litter boxes and it should not be less than the size of the largest used litter clump that can be expected to be encountered. In a preferred embodiment, the height of the side edges 40 of the angled front face 20 should be between three and a half (3½) and ten (10) centimeters with about five centimeters in length being preferred.

A rounded or convex back face 28 extends downward from the back portion 32 of the basket edge 16. The back face 28 should have the curvature of the back edge portion 32. The depth of the back face 28 should be at least that as the front face 14; however, it is contemplated for the back face 28 can be less than the height of the front face 14. The width of the rim 16 should be sufficient to provide an attachment point for a handle 30.

The handle 30 should be attached to the rim of the back face 28 at the center of the back face 28.

The bottom 26 of the base 10 generally extends laterally from the bottom edge of the front face 10 to a predetermined point, preferably about one-third to one-half of the length of the top of the base 10. The base 10 then begins to curve upward from the bottom surface reaching the rim 14, 16. It is important for the base 10 to initially curve downward from the front face 20 to allow the used litter to bee trapped in the scoop 2. The bottom point 44 of the curve of the base 10 is preferably between one centimeter (1) and two and a half (2½) centimeters (one quarter inch to one inch) lower than the bottom edge 24 of the front face 20.

The bottom surface of the basket 26 is preferred to be flat so that the user can rest the scoop on a surface, if desired. The base bottom 44 extends for a predetermined length from the bottom edge 24 of the front face 20 to an end point where the rear face 26 begins to curve upward until the back face 36 reaches the rim 16. The base 12 curves upward in all directions from the bottom surface 44 to connect with the sides of the basket upper rim or edge 16.

The overall size of the base 10 of the scoop 2 should not be too small or too large relative to the size of a litter box. If the base 10 of the scoop 2 is too small, it may result in the user having to make multiple passes through the litter to sufficiently clean the litter box. This is unwanted because it exposes the user to undesirable conditions for a longer period of time. If the base 10 is too large, it will not effectively clean and remove used litter from litter boxes because the scoop will not effectively reach all portions of the litter box. To achieve a preferred size of the scoop strainer 2, it is contemplated for the length of the front edge 14 to be between ten (10) and fifteen (15) centimeters long. The depth of the base 10 may be slightly smaller than the length of the front edge 14 to ease maneuverability. In a preferred embodiment, the depth of the base 10 is designed to be between seven and half (7½) and fourteen (14) centimeters. Also, in a preferred embodiment, the length of the front edge would be twelve and a half (12½) centimeters and the depth of the base would be about eleven and a half (11½) centimeters.

The entire base 10 may be formed from one solid piece of mesh to create the desired shape. It is also contemplated that the base 10 be formed from sheets of mesh which have been welded or otherwise joined together or otherwise connected to a wire frame to form the desired shape. For example, the base 10 can be first constructed from a metal wire frame forming the desired dimensions of the base 10. The wire-frame which would include the basket's upper edge 16, where the basket's upper edge 16 includes, the straight front edge 14, the back edge portion 32, and the side edges 38. A mesh material is then attached to it. If a wire frame is formed to construct the base, it should be fabricated from the same material used for the mesh which is attached to it. The mesh material could be attached to the frame in any method known in the art, such as welding or using an epoxy. It is also contemplated for the entire scoop to be injection molded as one continuous piece of plastic, or a plurality of plastic parts connected together to form one unit.

A handle 30 is attached to the back face 28 of the base 10. The longitudinal axis of the handle 30 should be aligned with the center point of the front edge 14. The handle 30 may be welded, screwed to or molded or otherwise attached with the base in any manner known in the art. The handle 30 should be a length and size which allows a user to easily operate the strainer scoop 2 and which does not cause the user's hand to come into contact with the litter during use. However, the handle 30 should not be overly long, otherwise maneuvering the scoop during use will prove more difficult, rendering the scoop ineffective. In preferred embodiments, the handle of the scoop should be between about twelve and half (12½) and eighteen (18) centimeters in length. The handle 30 should also be formed in a manner such that it is easy to grip and will not easily slip from a user's hand. Such non-slip features may be formed by knurling the handle during manufacture or in another manner in which grooves or indentations may be formed into or onto the handle. The handle 30 should have a curved shape to facilitate ease in gripping and maneuvering. It is also contemplated for the handle 30 to have an ergonomic shape to accommodate the shape of an average adult's hand. In a preferred embodiment, the handle 30 may be formed from the same material as used for the base 10. Therefore, in a preferred embodiment the entire scoop 2 would be made from the same material.

It is important for the entire scoop 2 to be made from a material which allows the scoop to be sterilized after each use. In a preferred embodiment, a plastic may be used which is resistant to high temperatures. In another preferred embodiment, the scoop is formed from one metal or one alloy; therefore only one sterilization process is needed to effectively sterilize the entire scoop. Any sterilization process known in the art is contemplated for the scoop which will effectively remove all biological materials. Such sterilization processes could include chemical or heat sterilization. These sterilization processes could be similar to those used to sterilize medical tools and equipment. It is also contemplated that the scoop may be sterilized in any home equipment which has the capability of creating steam or temperature levels which cause sterilization.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A scoop strainer for cleaning a cat litter box, comprising:
a scoop member 2 having a straight front upper edge 14 joined to arcuate upper side and rear edges 16 with a downward and inward sloping planar front face 20 extending from the front upper edge 14 to a bottom edge 24 and with convex sidewalls 38 and a rear wall, each curving inwardly and downwardly from the arcuate upper side and rear edges to a bottom surface 44, the side walls being integrally joined to side edges of the planar front face 10;
a handle 30 joined at one end to the upper rear edge;
said front face 10, convex side and rear walls 38 and bottom surface 44 being perforated with predetermined size, regularly spaced apertures.

2. The scoop strainer as in claim 1 wherein said scoop is made from a material capable of being sterilized.

3. The scoop strainer as in claim 1 wherein said apertures are uniform in size and shape.

4. The scoop strainer as in claim 3 wherein said apertures are square in shape.

5. The scoop strainer is in claim 4 wherein the square has sides between 2.5 mm and 3.5 mm.

6. The scoop strainer of claim 3 wherein the plurality of small holes are circular in shape.

7. The scoop strainer of claim 6 wherein the diameter of each hole is between 2.5 mm and 3.5 mm.

8. The scoop strainer of claim 1 wherein the scoop comprise wire mesh material.

9. The scoop strainer of claim 8 wherein the wire mesh material has square apertures, the side measuring between 2.5 mm and 3.5 mm.

10. The scoop strainer as in claim 1 wherein the front face is between 10 cm and 15 cm in length and 3.5 cm and 10 cm in width.

11. The scoop strainer of claim 1 wherein the arcuate sidewalls and rear wall have a radius of curvature between about 2.5 cm and 6 cm.
